(19) United States
(12) Patent Application Publication
(10) Pub. No.: US 2003/0111814 A1
(43) Pub. Date: Jun. 19, 2003

(54) Automotive independent suspension system using beam spring

(76) Inventors: Craig V. Sutton, South Lyon, MI (US); John Piasentin, Farmington, MI (US); Paul Eugene Beshears JR., Plymouth, MI (US)

Correspondence Address: Visteon Global Technologies, Inc., One Parklane Blvd., 728 Parklane Towers East, Dearborn, MI, 48126, US

(21) Appl. No.: 10/026,866

(22) Filed: Dec. 19, 2001

(51) Int. Cl. B60G 3/02

(52) U.S. Cl. 280/124.131

(57) ABSTRACT

A vehicle suspension system which uses a beam spring capable of substantial elastic deformation in two planes to provide for independent wheel suspension and to commonize suspension mounting systems in a vehicle chassis.

### CROSS REFERENCE TO RELATED APPLICATION

The present application is related to co-pending application Serial No. V201-0806, entitled “Automotive Beam Spring”, which is being concurrently filed herewith and which is incorporated herein by reference.

### BACKGROUND OF THE INVENTION

1. Field of the Invention

The present invention relates generally to vehicle suspensions, and more particularly to an automotive vehicle suspension in which composite beam springs are used to provide spring action in two planes.

2. Description of the Related Art

Previous automotive suspension systems using beam or leaf springs relied on substantial elastic deformation in only one plane. Substantial Inboard-outboard deformation of the spring was controlled by substantially higher spring rate stiffness in these planes created by wide leaf spring cross sections. Inboard-outboard deformation was typically not desired in these configurations since they were mainly paired with conventional beam axles which spanned the width of the vehicle and whose weight was completely unsprung by the suspension-that is the entire weight of the axle was attached to the spring and not dependent on the chassis.

The conventional leaf spring designs are excellent for beam axle applications. Conventional Leaf springs are not suited to independent suspension systems however. These independent suspension systems are characterized by axles with a differential attached to the chassis and use articulated halfshafts to transmit torque to the unsprung wheel ends. The wheel ends in an independent suspension system travel in an arc controlled by a control arm. Since these independently suspended wheel ends travel in an arc rather than straight up and down (requiring two planes of deformation), leaf springs with only one plane of elastic deformation are not suitable. Currently, these independent suspension systems rely on coil springs and control arms to provide a suitable suspension. Coil springs mount differently on a chassis than do leaf springs and so the two systems are not interchangeable on a common chassis. In addition, control arms for coil spring suspensions are often very heavy and rely on multiple attachment points and bushings to provide appropriate suspension characteristics. Coil springs and their control arms thus introduce added complexity and cost to an automobile over a conventional leaf spring design.

It would be desirable, therefore, to provide a suspension system, which mounts to a vehicle like a leaf spring yet provides the multiple-plane elastic deformation of a coil spring.

### BRIEF SUMMARY OF THE INVENTION

The present invention overcomes the disadvantages of the prior art approaches by providing a beam spring, which substantially elastically deforms in two planes.

It is an object and advantage of the present invention to provide an automotive suspension system comprising a chassis; a beam spring capable of substantial, elastic deformation in at least two planes, said beam spring having a first and second end, said beam spring further fixedly attached on said first end to said chassis, whereby said beam spring provides suspension to said chassis through substantial, elastic deformation in said at least 2 planes of said beam spring between said first end and said second end of said beam spring, and; a wheel end attached to said beam spring, whereby said wheel end is capable of mounting a road wheel.

These and other advantages, features and objects of the invention will become apparent from the drawings, detailed description and claims which follow.

### BRIEF DESCRIPTION OF THE DRAWINGS

FIG. 1 is a perspective view of a typical leaf spring suspension combined with a beam axle.

FIG. 2 is a perspective view of a beam spring attached to a rear chassis mount of a conventional leaf spring.

FIG. 3 is a perspective view of a beam spring suspension illustrating a control arm attached directly to a wheel end located at the second end of the beam spring.

FIG. 4 is a perspective view of a beam spring suspension that illustrates a vibrational damper, or shock absorber, attached to the wheelend.

FIG. 5 is a perspective view of a beam spring suspension that illustrates a vibrational damper, or shock absorber, attached to the beam spring itself.

FIG. 6 is a perspective view of a beam spring attached to both the front and rear chassis mounts of a conventional leaf spring system.

FIG. 7 is a perspective view of a beam spring attached at two points.

FIG. 8 is a perspective view of a beam spring having a variable cross section along its length to provide the desired elastic deformations.

FIG. 9 is a perspective view of a beam spring having a supplemental stiffener along its length to provide the desired elastic deformations.

### DETAILED DESCRIPTION OF THE PREFERRED EMBODIMENT(S)

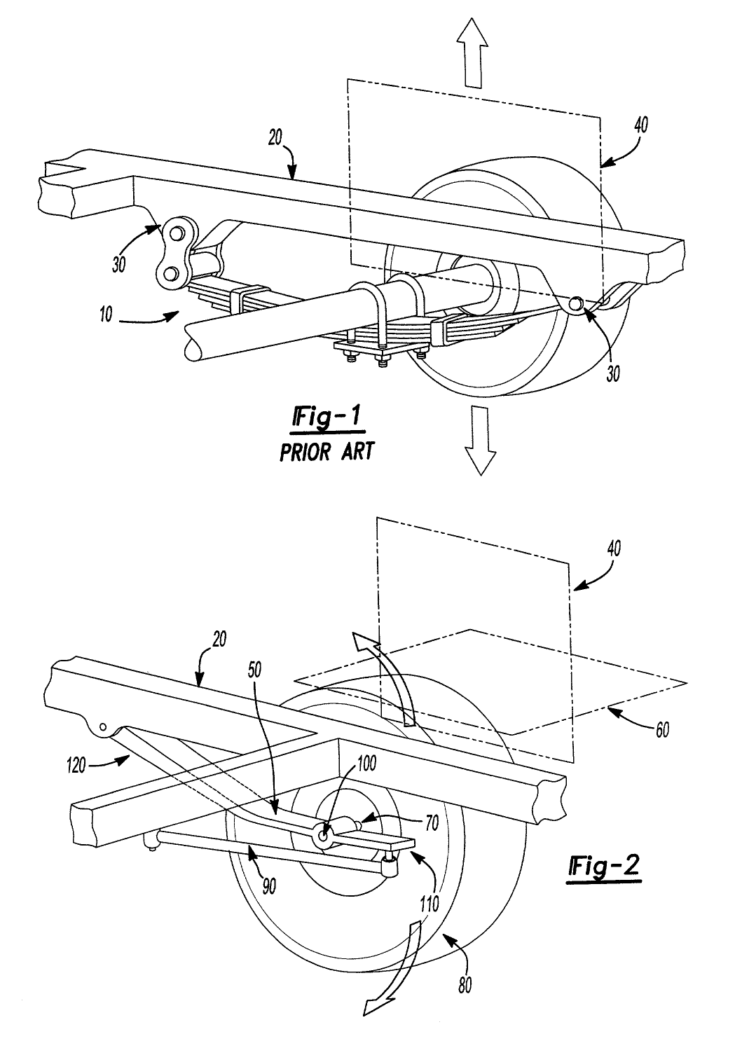

Referring now to the drawings, FIG. 1 shows a conventional leaf spring suspension. A leaf spring 10, is mounted to a chassis 20 with two bushings 30. This mounting configuration, when combined with the cross sectional stiffness characteristics of the wide leaf spring 10, insures that this suspension elastically deforms in a substantial manner only in the vertical plane 40.

FIG. 2 shows an automotive chassis of the present invention including a beam spring 50 capable of substantial, elastic deformation both the vertical 40 and horizontal planes 60. A wheel end 70 attached to beam spring 50 provides a method of attaching a road wheel 80 to the suspension. Through wheel end 70, beam spring 50 provides suspension to a chassis 20 through elastic deformation, which occurs along the length of beam spring 50 when loads change during vehicle maneuvers or with changing payloads or vehicle surfaces. The wheel end can take one of many different forms including a simple spindle/hub assembly or a halfshaft/hub assembly attached directly to the beam spring. The wheel end could also take the form of a knuckle/hub and tie rod end attachment, to allow for steering control of a road wheel 80, as in a front road wheel application. The wheel end may also include braking mechanisms such as disk and rotor or drum and pad brakes. This figure also shows a member, or control arm 90 attached to beam spring 50. While a control arm is not required to provide the necessary deformation, the addition of a control arm may in some instances be desirable for additional stiffness or control in the horizontal plane. Note that beam spring 50 is constrained to travel in an arc when used in conjunction with a control arm. The length of the control arm and the chassis attachment point of the control arm define the arc in which the beam spring travels. Other control arm designs and control arm attachments, using two or more points of control arm attachment, are suitable for the present invention. An ‘A’ shaped control arm, mounted at two points on the chassis, and one point to the beam spring or wheel end, can provide additional suspension characteristics. As an example, an ‘A’ shaped control arm which pivots substantially parallel to the road wheel axes will provide more resistance to wheel nibble and undesirable suspension vibration on a steered road wheel. Furthermore, this figure shows wheel end 70 attached to beam spring 50 at a point 100 between a first end 120 and a second end 110 of beam spring 50. The location of wheel end 70, beam spring 50, and control arm 90 with respect to each other may be merely in order to provide attachment points for control arms or shock absorbers, or may be done for performance reasons, i.e. the location of the various suspension points may affect suspension geometry and performance. FIG. 2 also illustrates one way to attach a wheel end 70 attached to a beam spring 50 at a point between a first end 120 and a second end 110.

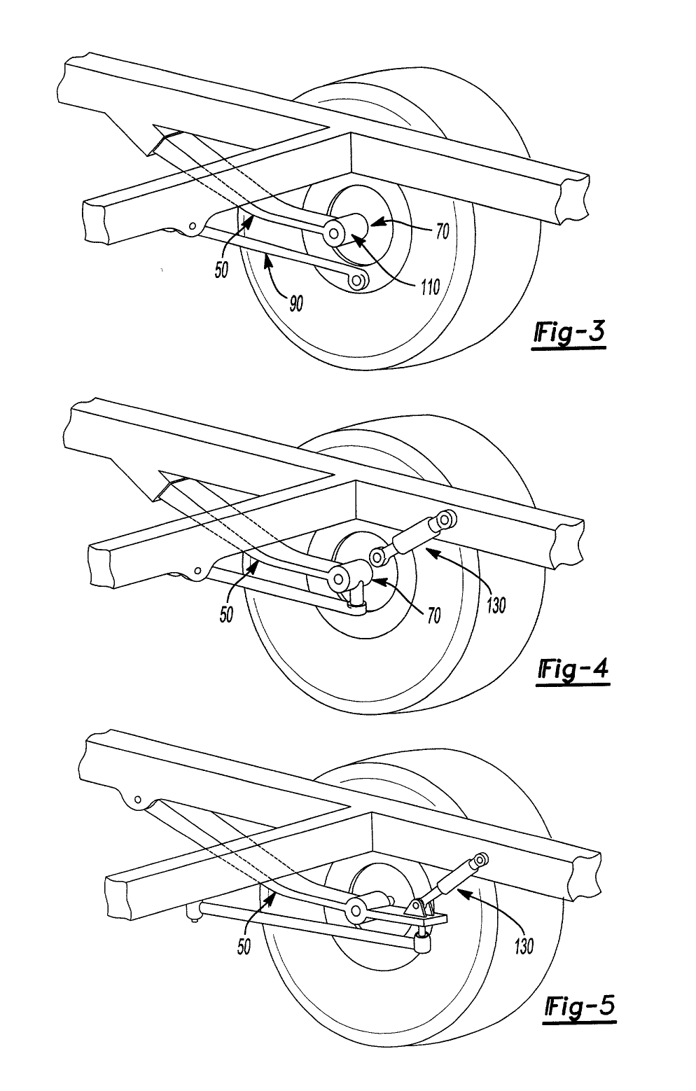

FIG. 3 shows a beam spring 50 with a member, or control arm 90 attached to wheel end, or fitting 70. This figure also illustrates wheel end 70 attached to second end 110 of beam spring 50. This may be done for suspension performance reasons or for packaging efficiency as discussed above.

FIG. 4 shows a beam spring 50 with a shock absorber 130 attached to wheel end 70.

FIG. 5 shows a beam spring 50 with a shock absorber 130 attached to beam spring 50.

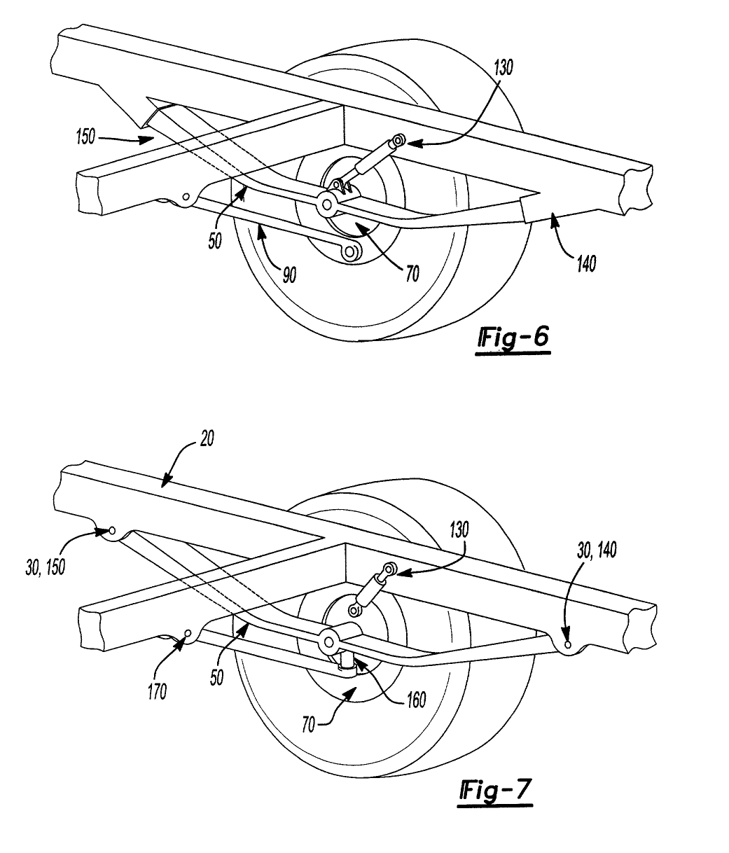

FIG. 6 shows a beam spring 50 with two attachment points 140 and 150 to chassis 20. The use of two attachment points may be for packaging or performance reasons. This figure also shows an optional control arm, or stiff member 90 attached to wheel end 70 and a shock absorber, or vibrational damper 130 attached to beam spring 50.

FIG. 7 shows a beam spring 50 with two attachment points 140 and 150 to chassis 20. In this figure, a shock absorber 130 is attached to wheel end 70 and a control arm 90 is attached to beam spring 50. As in a beam spring attached with a single point, the location of beam spring attachment points 140 and 150, control arm attachment points 160 and 170, wheel end 70, and shock absorber 130 in relation to each other may be for packaging or performance reasons. Beam Springs with two attachment points may be attached using bushings 30.

The beam spring itself may be made of many different materials including composites, metal, in-cast metals, and plastic-metal hybrid materials. The invention uses varied, controlled rates of stiffness along various axes throughout the beam spring so as to tune the stiffness response of the beam spring in the multiple planes in which it must elastically deform. There are many ways of varying the stiffness rates of springs along various axes throughout the material from which the spring is constructed. For example, the cross sectional widths of the beam spring in different axes transverse to its longitudinal length are varied to provide the stiffness response of the beam spring in the multiple planes in which it must elastically deform. Specific embodiments for varying the cross sectional widths to generate a desired stiffness response of springs in multiple planes include using circular cross sections at the beam spring ends compared to a middle cross section that is rectangular in cross section and substantially wider in the horizontal plane than in the vertical plane as shown in FIG. 8. This configuration offers relatively high stiffness horizontally at the midsection but allows horizontal elastic deformation to be concentrated at the ends, where it is easier to control the deformation movement in the horizontal plane, without undue vibration or ‘wag’. Alternately, wide, flat cross sections may be employed at the ends to promote durability, while using a smaller, round midsection for elastic deformation in the horizontal plane. Other cross sections may be used in multiple combinations to tune the response of the suspension-for instance progressively increasing spring rates may be developed by increasing the stiffness of the beam spring along its length by varying the cross sectional shape and/or dimensions.

The beam spring may be attached in a variety of ways. One way to attach a single point beam spring is to form the first end of the beam spring to cooperatively nest over an existing leaf spring mount on the chassis as shown in FIG. 7. A hole provided in the beam spring, which matches that of the existing chassis mount, can be pinned to fixedly attach the beam spring to the chassis. Features on the beam spring can be incorporated to provide leverage against the chassis when mounted with a pin in order to prevent rotation of the beam spring about the fixing pin. In this way, a beam spring attached by a single point can elastically support a changing suspension load.

The beam spring may also be attached to the chassis at two points. One way to attach a dual point beam spring is to form each end of the beam spring to cooperatively nest over a corresponding, existing leaf spring mount on the chassis, similar to the fashion described for a single point beam spring above.

Another way of attaching a beam spring to the chassis includes a sleeve attached to the chassis, designed to slip over an end of the beam spring. The beam spring may then be pinned, glued or crimped to fixedly attach it to the frame and prevent rotation of the end of the beam spring in relation to the chassis.

The attachment mechanisms and configuration of control arm or arms and the shock absorber to the beam spring suspension are dependent on the particular configuration and materials used.

Various other modifications to the present invention may occur to those skilled in the art to which the present invention pertains. For example, the inclusion of halfshafts and a sprung differential and/or transmission to the beam suspension system. Additionally, control arms with more than two attachment points may be employed. Other modifications not explicitly mentioned herein are also possible and within the scope of the present invention. It is the following claims, including all equivalents, which define the scope of the present invention.

What is claimed is:

1. An automotive suspension system comprising:
a chassis;
a beam spring capable of substantial, elastic deformation in at least two planes, said beam spring having a first and second end, said beam spring further fixedly attached on said first end to said chassis, whereby said beam spring provides suspension to said chassis through substantial, elastic deformation in said at least 2 planes of said beam spring between said first end and said second end of said beam spring, and;
a wheel end attached to said beam spring, whereby said wheel end is capable of mounting a road wheel.

2. A suspension system as in claim 1, further comprising a member, having a first end and second end, said first end rotatably attached to a point fixed in relation to said chassis, said second end rotatably attached to said beam spring.

3. A suspension system as in claim 1, further comprising a member, having a first end and second end, said first end rotatably attached to a point fixed in relation to said chassis, said second end rotatably attached to said wheel end.

4. A suspension system as in claim 1, further comprising a shock absorber attached to said wheel end and said chassis.

5. A suspension system as in claim 1, further comprising a shock absorber attached to said beam spring and said chassis.

6. A suspension system as in claim 1, wherein said wheel end is attached to said second end of said beam spring.

7. A suspension system as in claim 1, wherein said beam spring is made of a thermoset composite material.

8. A suspension system as in claim 1, wherein said beam spring is made from a thermoplastic composite material.

9. A suspension system as in claim 1, wherein said beam spring is made from a metal and plastic hybrid material.

10. A suspension system as in claim 1, wherein said beam spring is made from in-cast metallic components.

11. An automotive suspension system comprising:
a chassis;
a beam spring capable of substantial, elastic deformation in at least two planes, whereby said beam spring provides suspension to said chassis through substantial, elastic deformation in said at least 2 planes of said beam spring between a first suspension point and a second suspension point on said beam spring, said beam spring having a first end and a second end, further wherein said beam spring is attached to said chassis at said first suspension point and said second suspension point, and;
a wheel end attached to said beam spring, whereby said wheel end is capable of mounting a road wheel.

12. A suspension system as in claim 11, further comprising a member having a first and second end, said first end rotatably attached to a point fixed with relation to said chassis, said second end attached to said beam spring.

13. A suspension system as in claim 11, further comprising a member having a first and second end, said first end rotatably attached to a point fixed with relation to said chassis, said second end attached to said wheel end.

14. A suspension system as in claim 11 further comprising a shock absorber attached to said wheel end and said chassis.

15. A suspension system as in claim 11 further comprising a shock absorber attached to said beam spring and said chassis.

16. A suspension system as in claim 11, further wherein said beam spring is rotatably attached to said chassis at said first suspension point and said second suspension point with a first bushing and a second bushing.

17. A system comprising:
a frame member;
a suspension member having a first longitudinal section and at least other longitudinal section, wherein said first longitudinal section is less stiff than said at least one other longitudinal section, said suspension member capable of substantial, elastic deformation in at least two orthogonal planes, and further having a first end and a second end, and;
a fitting attached to said suspension member, said fitting capable of rotatably attaching to a wheel.

18. A system as in claim 17, further comprising a stiff member having a first end and a second end, said first end rotatably attached to appoint fixed in relation to said frame member and said second end rotatably attached to said suspension member.

19. A system as in claim 17, further comprising a stiff member having a first end and a second end, said first end rotatably attached to appoint fixed in relation to said frame member and said second end rotatably attached to said fitting.

20. A system as in claim 17, further comprising a vibrational damper, said vibrational damper coupled to said fitting and said frame member.

21. A system as in claim 17, further comprising a vibrational damper, said vibrational damper coupled to said suspension member and said frame member.
